(19) United States
(12) Patent Application Publication
(10) Pub. No.: US 2026/0352913 A1
(43) Pub. Date: Nov. 5, 2026

(54) CONTEXT-BASED CONFIGURATION OF MEDIA PLAYBACK SYSTEM

(71) Applicant: Sonos Inc., Goleta, CA (US)

(72) Inventors: Jonathan Cole Harris, Santa Barbara, CA (US); Nicholas Millington, Santa Barbara, CA (US)

(21) Appl. No.: 19/659,837

(22) Filed: Apr. 27, 2026

Related U.S. Application Data
(60) Provisional application No. 63/798,804, filed on May 2, 2025.

(51) Int. Cl. H04N 21/43; G06F 3/16; H04N 21/4363

(52) U.S. Cl. CPC H04N 21/4307; G06F 3/165; H04N 21/43635

(57) ABSTRACT

A network device can be configured to join a bonded group including playback device(s) configured to play back audio content associated with visual content in lip-synchrony with rendering of the visual content on a display device that is connected to the network device via a wired communication interface. The network device may be further configured to obtain the visual content via a wireless communication interface, transmit the visual content to the display device via the wired communication interface, select, based on at least one condition, either a first configuration of the bonded group or a second configuration of the bonded group, the at least one condition including one or more of (i) a type of connection between the network device and the display device or (ii) a capability of the playback device(s), and operate in the bonded group according to the first or second configuration of the bonded group.

### CROSS-REFERENCE TO RELATED APPLICATION

The present application claims priority under 35 U.S.C. § 119(e) to U.S. Provisional Patent Application No. 63/798,804 titled “CONTEXT-BASED CONFIGURATION OF MEDIA PLAYBACK SYSTEM” and filed on May 2, 2025, which application is hereby incorporated herein by reference in its entirety.

### FIELD OF THE DISCLOSURE

The present disclosure is related to consumer goods and, more particularly, to media playback or aspects thereof.

### BACKGROUND

Wireless home sound systems can allow people to experience music from many sources via one or more networked playback devices. Through a program installed on a control device (e.g., smartphone, tablet, computer, or other device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### SUMMARY

In one example, a network device comprises: a wireless communication interface including at least one radio configured to communicate within a wireless network; a wired communication interface; at least one processor; and at least one non-transitory computer-readable medium. The at least one non-transitory computer-readable medium stores program instructions that are executable by the at least one processor such that the network device is configured to: join a bonded group comprising at least one playback device configured to play back audio content associated with visual content in lip-synchrony with rendering of the visual content on a display device that is connected to the network device via the wired communication interface; obtain the visual content via the wireless communication interface; transmit the visual content to the display device via the wired communication interface; select, based on at least one condition, either a first configuration of the bonded group or a second configuration of the bonded group, the at least one condition including one or more of (i) a type of connection between the network device and the display device, or (ii) a capability of the at least one playback device; and operate in the bonded group according to the first configuration of the bonded group or the second configuration of the bonded group.

Another example is directed to a method of operating a media playback system comprising a primary playback device, a network device, and a plurality of satellite playback devices. The example method comprises: forming a bonded group that includes the plurality of satellite playback devices, the primary playback device, and the network device, the plurality of satellite playback devices being configured, in the bonded group, to play back audio content associated with visual content in lip-synchrony with rendering of the visual content on a display device that is connected to the network device; determining a type of connection between the display device and the network device; determining capabilities of the plurality of satellite playback devices; selecting, based on the type of connection between the display device and the network device and/or based on the capabilities of the plurality of satellite playback devices, a first configuration of the bonded group or a second configuration of the bonded group; and operating the bonded group according to either the first configuration or the second configuration. In one example, operating in the bonded group in the first configuration includes: obtaining, with the network device, the audio content via a network access point; transmitting the audio content from the network device to the plurality of satellite playback devices and to the primary playback device; and transmitting the visual content from the network device to the display device. In one example, operating the bonded group in the second configuration includes: obtaining, with the primary playback device, the audio content via the network access point; transmitting the audio content from the primary playback device to the plurality of satellite playback devices; and transmitting the visual content from the network device to the display device.

According to another example, a network device comprises: a wireless communication interface including a fronthaul radio configured to communicate over a first wireless network and a backhaul radio configured to communicate over a second wireless network; a first High-Definition Multimedia Interface (HDMI) interface; at least one processor; and at least one non-transitory computer-readable medium. The at least one non-transitory computer-readable medium stores program instructions that are executable by the at least one processor such that the network device is configured to: join a bonded group comprising a plurality of playback devices that play back audio content associated with visual content in lip-synchrony with rendering of the visual content on a display device that is connected to the network device via the first HDMI interface; obtain the visual content; transmit the visual content to the display device via the first HDMI interface; select an operating configuration of the bonded group based at least one of a type of the first HDMI interface and wireless networking capabilities of the plurality of playback devices; and operate in a selected operating configuration of the bonded group. In one example, to operate in a first selected operating configuration includes to: obtain the audio content; establish, with the fronthaul radio, the first wireless network among the network device and the plurality of playback devices; and transmit the audio content to the plurality of playback devices via the first wireless network. In one example, to operate in a second selected operating configuration includes to instruct a first playback device of the plurality of playback devices to obtain the audio content and to distribute the audio content to others of the plurality of playback devices.

### BRIEF DESCRIPTION OF THE DRAWINGS

Aspects and advantages of the technology described herein may be better understood with regard to the following description, appended claims, and accompanying drawings, as listed below. A person skilled in the relevant art will understand that the elements shown in the drawings are for purposes of illustrations, and variations, including different and/or additional elements and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIGS. 1I-1L are schematic diagrams of corresponding media playback system zones.

FIG. 1M is a schematic diagram of media playback system areas.

FIG. 2A is a front isometric view of a playback device configured in accordance with aspects of the disclosed technology.

FIG. 2B is a front isometric view of the playback device of FIG. 2A without a grille.

FIG. 2C is an exploded view of the playback device of FIG. 2A.

FIG. 3A is a front view of a network microphone device configured in accordance with aspects of the disclosed technology.

FIG. 3B is a side isometric view of the network microphone device of FIG. 3A.

FIG. 3C is an exploded view of the network microphone device of FIGS. 3A and 3B.

FIG. 3D is an enlarged view of a portion of FIG. 3B.

FIG. 3E is a block diagram of the network microphone device of FIGS. 3A-3D.

FIG. 3F is a schematic diagram of an example voice input.

FIGS. 4A-D are schematic diagrams of a control device in various stages of operation in accordance with aspects of the disclosed technology.

FIG. 5 is a front view of a control device.

FIG. 6 is a message flow diagram of a media playback system.

FIG. 7 is a block diagram illustrating a first configuration of a media playback system in accordance with aspects of the disclosed technology.

FIG. 8 is a block diagram illustrating a second configuration of a media playback system in accordance with aspects of the disclosed technology.

FIG. 9A is a flow diagram of one example of a method of operating a bonded group in a media playback system, in accordance with aspects of the disclosed technology.

FIG. 9B is a flow diagram of another example of the method of FIG. 9A, in accordance with aspects of the disclosed technology.

FIG. 9C is a flow diagram illustrating examples of portions of the methods of FIGS. 9A and/or 9B, in accordance with aspects of the disclosed technology.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Some home theater architectures include a primary playback device, such as a soundbar or other home theater controller device, that is configured to (i) receive audio data via a High-Definition Multimedia Interface (HDMI) Audio Return Channel (ARC) and (ii) wirelessly transmit the received audio to several satellite speakers, e.g., rear speakers, side speakers, subwoofers, overhead speakers, and so on. The soundbar can be connected to a display device, such as a television, via HDMI input/output (I/O) ports on the display device and the soundbar. In some instances, in addition to transmitting the received audio to the satellite speakers, the soundbar may also play back one or more audio channels of the received audio, typically in synchrony with playback of other audio channels of the received audio by the satellite speakers.

In some examples, the soundbar can be directly connected to the display device via, for example, a cable or other connection, with the display device providing the soundbar with the audio to be distributed to the satellite speakers. However, this arrangement may have a few disadvantages. For example, with this configuration, it can be challenging to accommodate a larger number of satellite speakers because, in some instances, to maintain lip synchronization between playback of the audio data by the speakers and playback of the corresponding video data by the television, the audio data must be wirelessly transmitted to all of the satellite speakers within tens of milliseconds of a frame being rendered by the television. Thus, to meet the short time window requirements for maintaining lip synchrony between playback of the audio data and the video data, some wireless home theater architectures can only accommodate a limited number of satellite speakers. Furthermore, placement of the soundbar relative to the display device may be constrained by the cable connection.

To address these issues, home theater systems according to certain examples include a primary device (which may or may not be a playback device and which may also be referred to as a home theater coordinator or coordinator device) that is configured to obtain both audio and video data, and to distribute the video data to the display device and the audio data to one or more playback devices (e.g., the soundbar and/or satellite speakers). In this configuration the primary device can add an arbitrary delay before providing the video data to the display device for playback to accommodate the time required to wirelessly transmit the corresponding audio data to the satellite speakers. While this configuration can mitigate stringent timing considerations associated with maintaining lip synchrony between video and audio playback, various other challenges may remain.

For example, different playback devices, including the soundbar and/or individual satellite speakers, can have different wireless networking capabilities and/or different levels of computing/processing power. For example, some playback devices may only support older versions of the 802.11 standard for wireless communications (e.g., 802.11n or WI-FI 4). As such, these playback devices may not support more recent wireless communication schemes, such as those using 6 GHz wireless networks and/or certain data multiplexing schemes that permit higher-bandwidth or faster transmission of the audio data among playback devices. Furthermore, a user may set up their home theater system in a manner that prevents certain networking configurations and/or communication schemes among network devices in the home theater system. These factors can impact the manner in which a primary device can be configured and operated in home theater systems.

Accordingly, examples described herein provide techniques by which a network device having the capability to act as a home theater primary device can determine various parameters, attributes, or configurations of devices in a networked group (e.g., a home theater group) that may affect operation of the primary network device, and alter its operation accordingly. For example, when in a bonded group with one or more playback devices, the primary network device may determine capabilities of the one or more playback devices, such as their networking/communication capabilities (e.g., whether one or more individual playback devices support a 6 GHz wireless network connection). The primary network device may further determine whether its connection set-up with a display device allows the primary network device to distribute audio and video data among the playback devices and the display device, respectively, or whether a different data distribution arrangement is needed or warranted. Based on these determinations, the primary network device can alter is operation and/or select a particular configuration of the bonded group, as described further detail below.

Thus, examples described herein provide techniques by which a network device can determine, during a bonding process, for example, certain conditions (such as connectivity arrangements, type of content to be played, and/or capabilities of other devices in the bonded group) of the bonded group and select a configuration based thereon. For example, a network device may comprise a wireless communication interface including at least one radio configured to communicate within a wireless network, a wired communication interface, and at least one processor. The network device may further comprise at least one non-transitory computer-readable medium storing program instructions that are executable by the at least one processor such that the network device is configured to perform the following actions. For example, the network device may join a bonded group comprising at least one playback device configured to play back audio content associated with visual content in lip-synchrony with rendering of the visual content on a display device that is connected to the network device via the wired communication interface and obtain the visual content via the wireless communication interface. The network device may further transmit the visual content to the display device via the wired communication interface. The network device may further select, based on at least one condition, either a first configuration of the bonded group or a second configuration of the bonded group, the at least one condition including one or more of (i) a type of connection between the network device and the display device or (ii) a capability of the at least one playback device. The network device may operate in the bonded group according to the first configuration of the bonded group or the second configuration of the bonded group.

These and other aspects are described in more detail below.

While some examples described herein may refer to functions performed by given actors such as “users,” “listeners,” and/or other entities, it should be understood that such references are for purposes of explanation only. The claims should not be interpreted to require action by any such example actor unless explicitly required by the language of the claims themselves.

In the Figures, identical reference numbers identify generally similar, and/or identical, elements. To facilitate the discussion of any particular element, the most significant digit or digits of a reference number refers to the Figure in which that element is first introduced. Many of the details, dimensions, angles, and other attributes shown in the Figures are merely illustrative of particular examples of the disclosed technology. Accordingly, other examples can have other details, dimensions, angles, and/or attributes without departing from the intended scope of the disclosure. In addition, those of ordinary skill in the art will appreciate that further examples of the various disclosed technologies can be practiced without several of the details described below, or in combinations different from those explicitly described and/or illustrated herein.

### II. Suitable Operating Environment

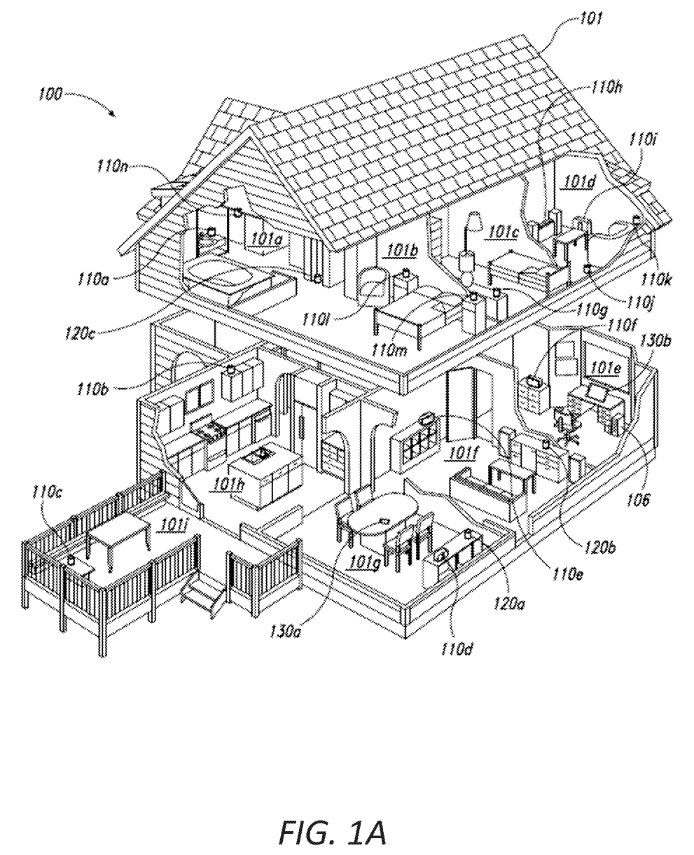

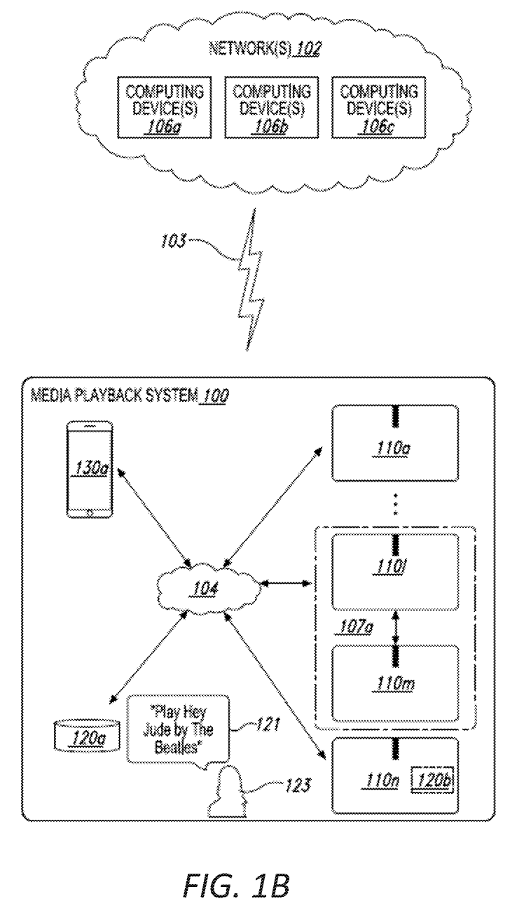

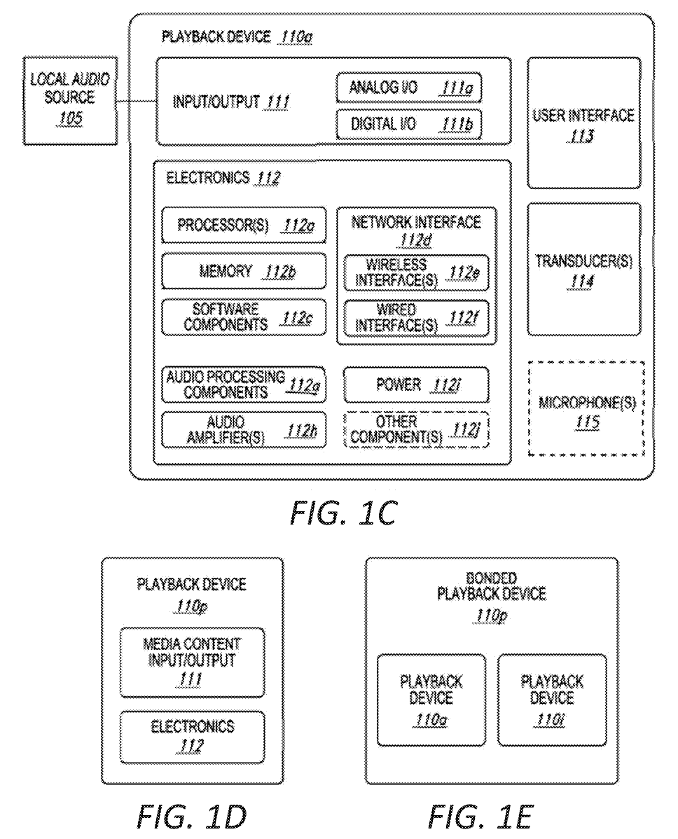

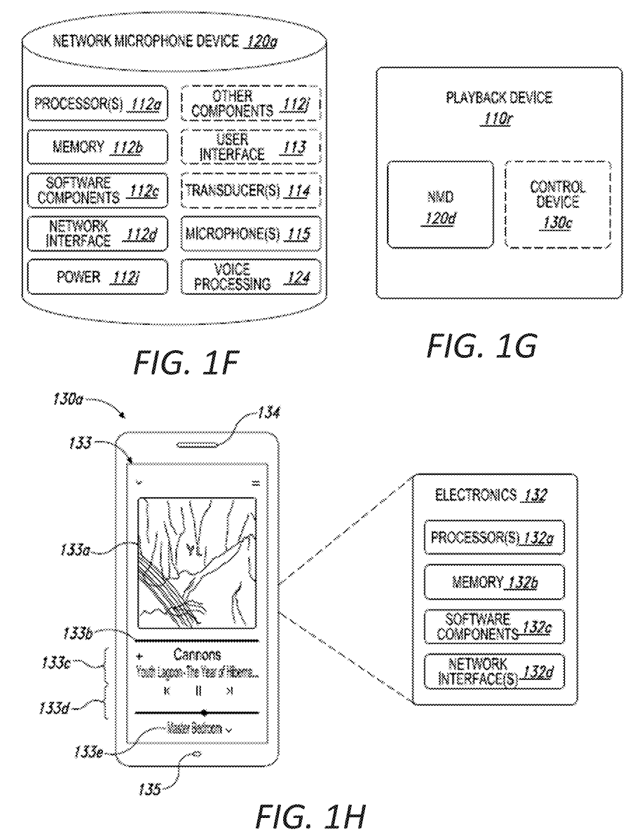

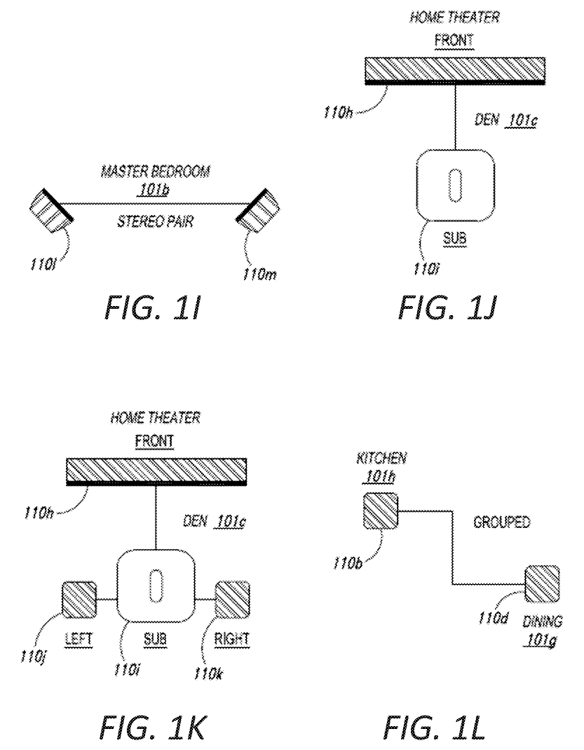

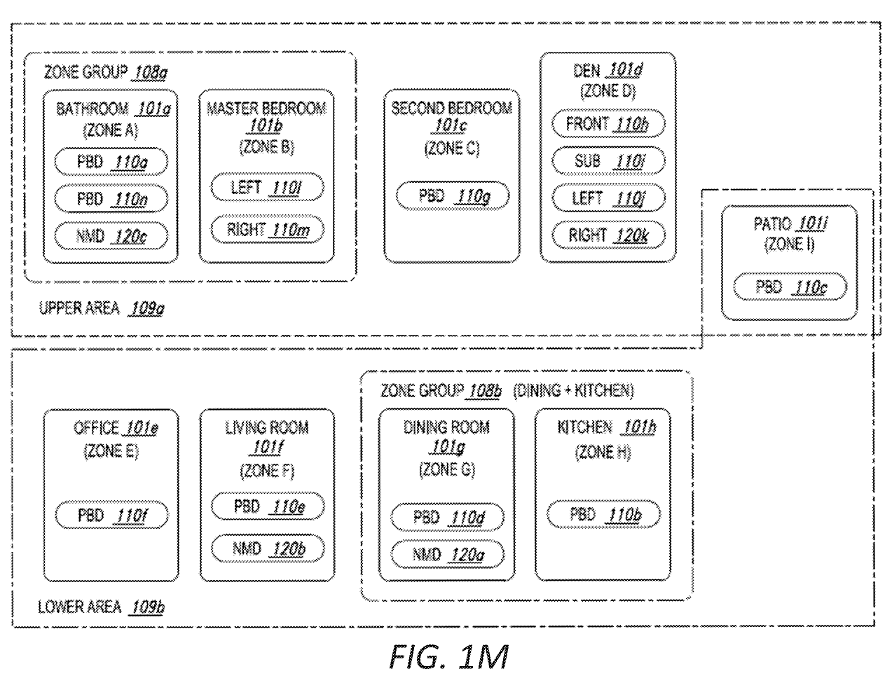

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices, etc.) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation, etc.). In some embodiments, for example, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various embodiments of the disclosure are described in greater detail below with respect to FIGS. 1B-6.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane, etc.), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the second bedroom 101c, the office 101e, the living room 101f, the dining room 101g, the kitchen 101h, and the outdoor patio 101i each include one playback device 110, and the master bathroom 101a, the master bedroom 101b, and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-k can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B, 1E, 1I, and 1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Patent No. 8,234,395 entitled, “System and method for synchronizing operations among a plurality of independently clocked digital data processing devices,” which is incorporated herein by reference in its entirety.

### a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks), etc. The cloud network 102 is configured to deliver media content (e.g., audio content, video content, photographs, social media content, etc.) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WI-FI network, a BLUETOOTH network, a Z-WAVE network, a ZIGBEE network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WI-FI” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household or commercial facility communication network (e.g., a household or commercial facility WI-FI network). In some embodiments, the links 103 and the network 104 comprise one or more of the same networks. In some aspects, for example, the links 103 and the network 104 comprise a telecommunication network (e.g., an LTE network, a 5G network, etc.). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud servers that host cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length, etc.) and other associated information (e.g., URIs, URLs, etc.) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1I-1M.

The media playback system 100 includes the NMDs 120a and 120b, each comprising one or more microphones configured to receive voice utterances from a user. In the illustrated embodiment of FIG. 1B, the NMD 120a is a standalone device and the NMD 120b is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS, AMAZON, GOOGLE, APPLE, MICROSOFT, etc.). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user’s voice utterance.

### b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WI-FI, BLUETOOTH, or another suitable communication link. In certain embodiments, the analog I/O 111a and the digital I/O 111b comprise interfaces (e.g., ports, plugs, jacks, etc.) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a BLUETOOTH connection, an ad hoc wired or wireless communication network, and/or another suitable communication link). The local audio source 105 can comprise, for example, a mobile device (e.g., a smartphone, a tablet, a laptop computer, etc.) or another suitable audio component (e.g., a television, a desktop computer, an amplifier, a phonograph (such as an LP turntable), a Blu-ray player, a memory storing digital media files, etc.). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens, etc.), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases, etc.).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone, etc.).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Patent No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds, etc.) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receive and process the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WI-FI, BLUETOOTH, LTE, etc.). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 exclude the network interface 112d altogether and transmit and receive media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DACs), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omit the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers 112h include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 include a single one of the amplifiers 112h configured to output amplified audio signals to a plurality of the transducers 114. In some other embodiments, the electronics 112 omit the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, Sonos, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” “AMP,” “PORT,” and “SUB.” Other suitable playback devices may additionally or alternatively be used to implement the playback devices of example embodiments disclosed herein. Additionally, one of ordinary skill in the art will appreciate that a playback device is not limited to the examples described herein or to Sonos product offerings. In some embodiments, for example, one or more playback devices 110 comprise wired or wireless headphones (e.g., over-the-ear headphones, on-ear headphones, in-ear earphones, etc.). In other embodiments, one or more of the playback devices 110 comprise a docking station and/or an interface configured to interact with a docking station for personal mobile media playback devices. In certain embodiments, a playback device may be integral to another device or component such as a television, an LP turntable, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

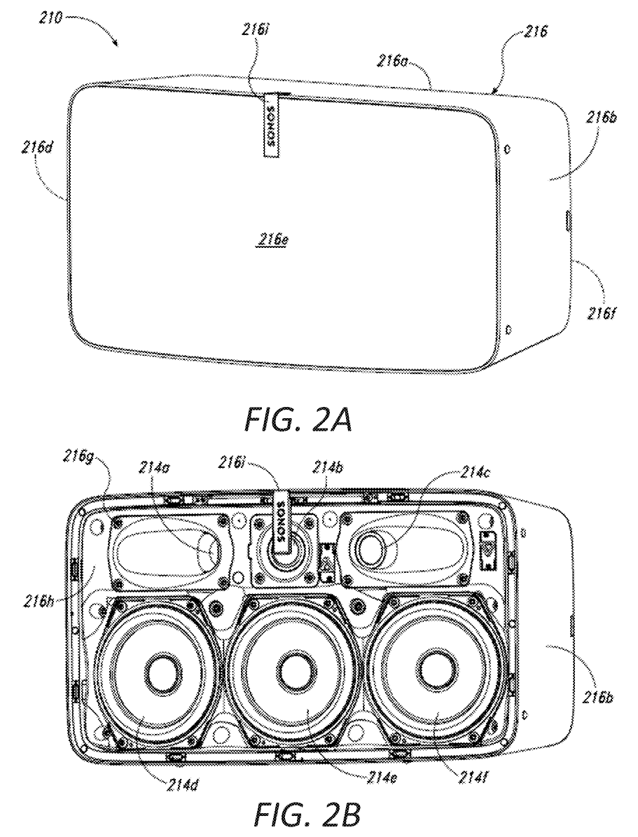

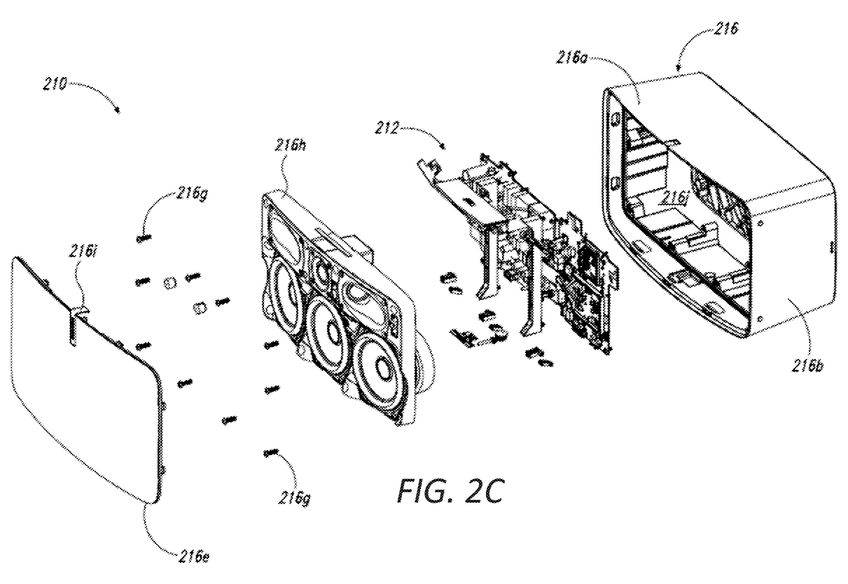

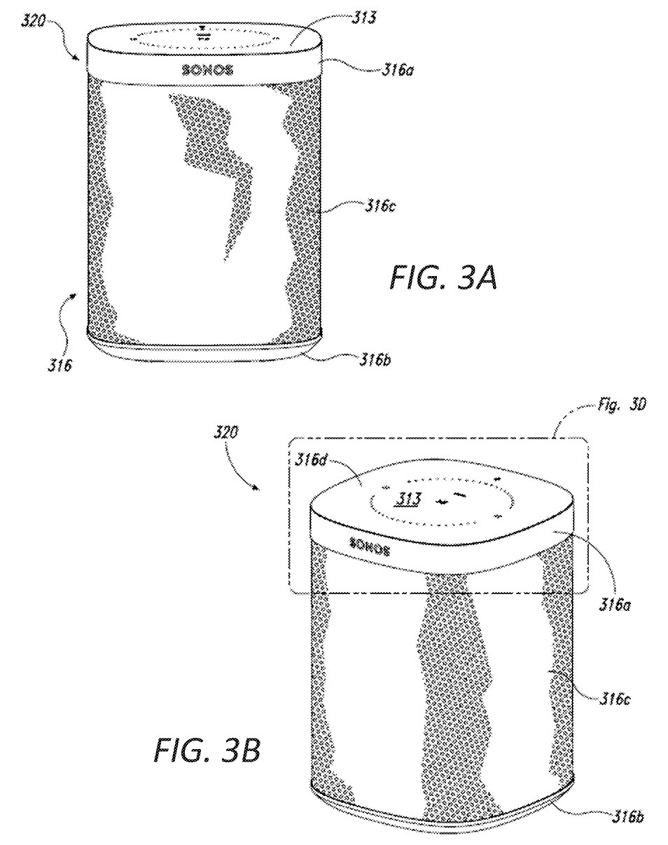

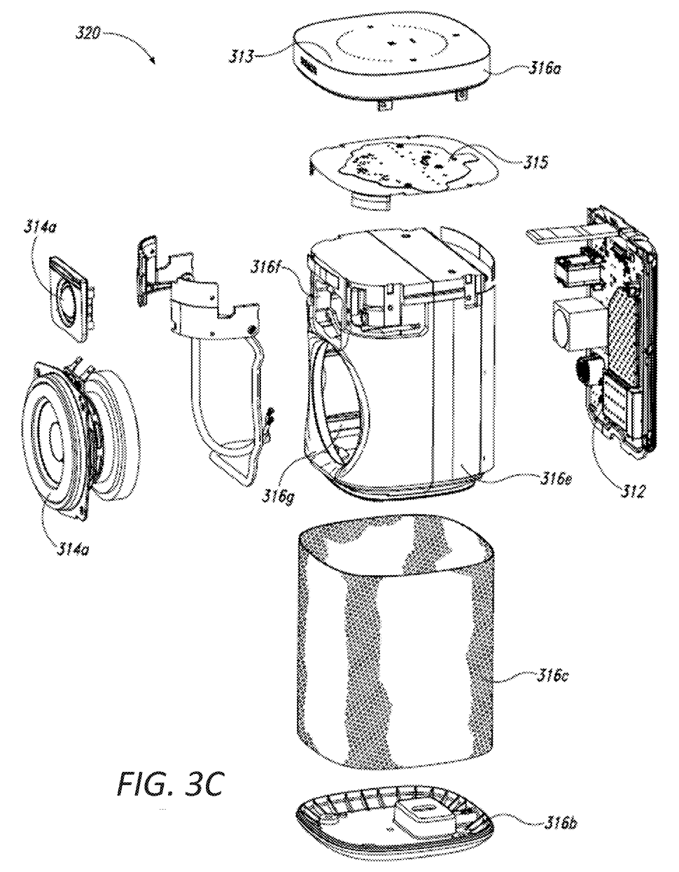

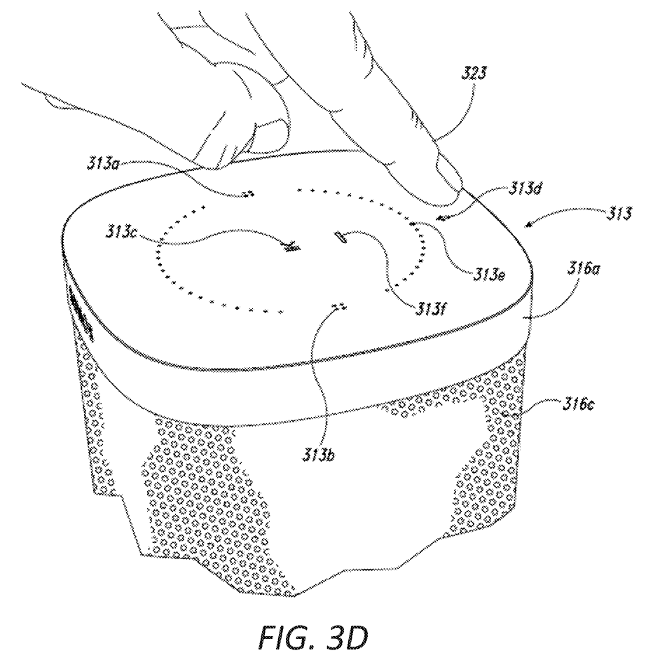

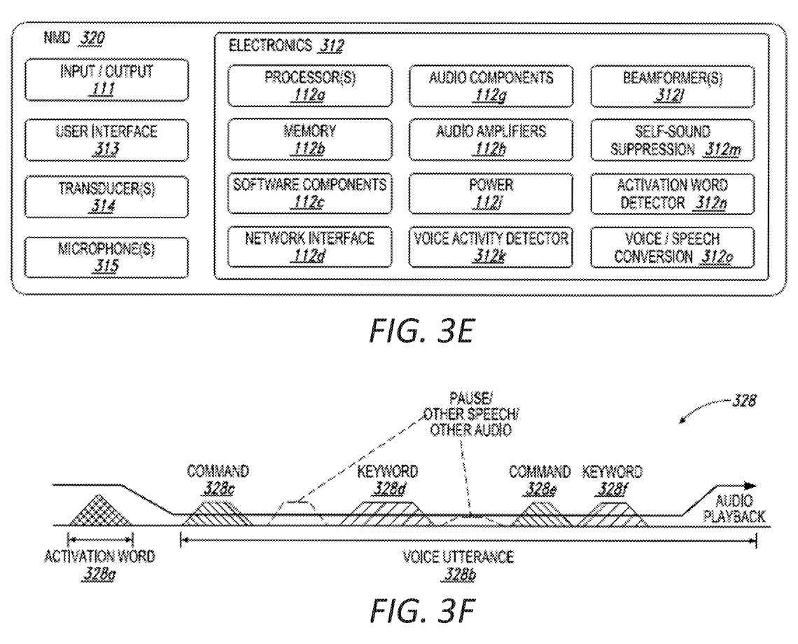

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is a full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A-3D

### c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 112h, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers, etc.).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1C) configured to receive user input (e.g., touch input, voice input, etc.) without a separate control device. In other embodiments, however, the playback device 110r receives commands from another control device (e.g., the control device 130a of FIG. 1B). Additional NMD embodiments are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON VAS, a user might speak the activation word "Alexa." Other examples include "Ok, Google" for invoking the GOOGLE VAS and "Hey, Siri" for invoking the APPLE VAS.

After detecting the activation word, voice processing components 124 monitor the microphone data for an accompanying user request in the voice input. The user request may include, for example, a command to control a third-party device, such as a thermostat (e.g., NEST thermostat), an illumination device (e.g., a PHILIPS HUE lighting device), or a media playback device (e.g., a SONOS playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

### d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone^{™} _{,} an Android phone, etc.) on which media playback system controller application software is installed. In some embodiments, the control device 130a comprises, for example, a tablet (e.g., an iPad^{™}), a computer (e.g., a laptop computer, a desktop computer, etc.), and/or another suitable device (e.g., a television, an automobile audio head unit, an IoT device, etc.). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 132b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE, etc.). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection, etc.) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups can be found below with respect to FIGS. 1I-1M.

The user interface 133 is configured to receive user input and can facilitate control of the media playback system 100. The user interface 133 includes media content art 133a (e.g., album art, lyrics, videos, etc.), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year, etc.) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone^{™} _{,} an Android phone, etc.). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

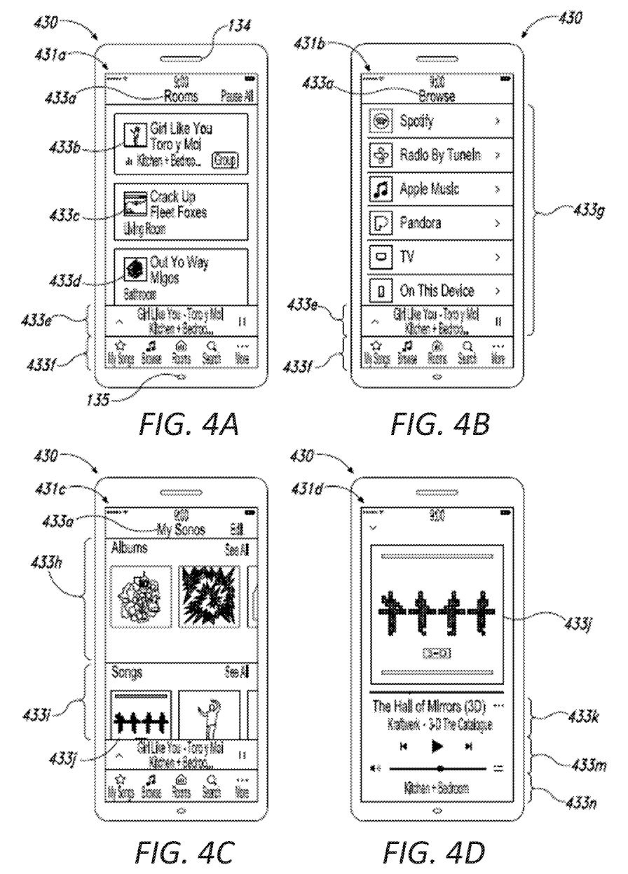

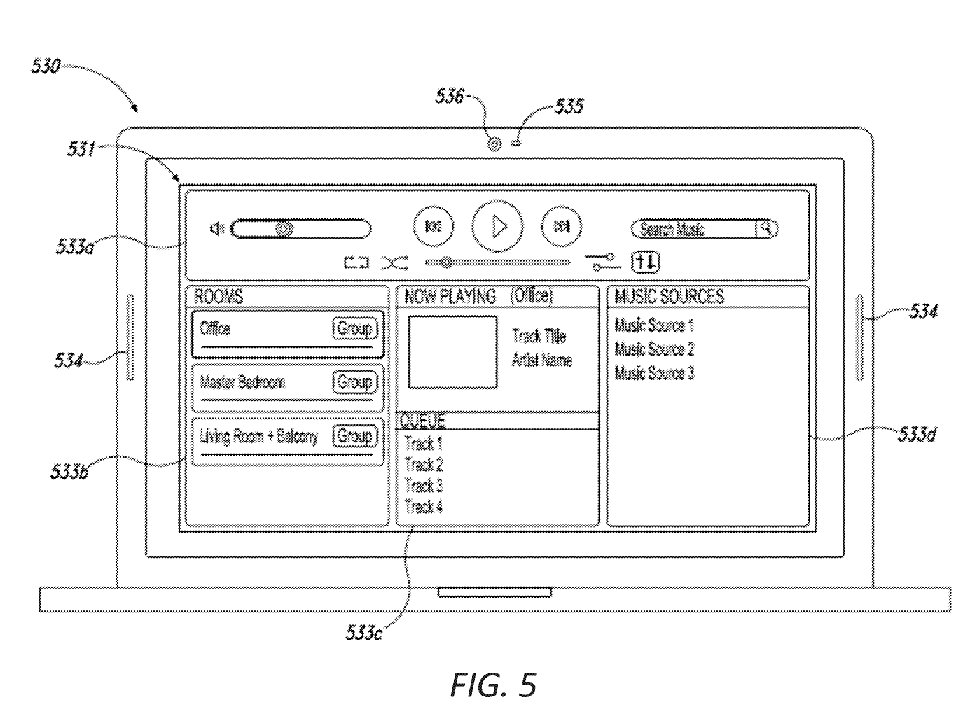

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound, etc.) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones. Additional control device embodiments are described in further detail below with respect to FIGS. 4A-4D and 5.

### e. Suitable Playback Device Configurations

FIGS. 1I-1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone B. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110b and 110d can be merged to form a merged group or a zone group 108b. The merged playback devices 110b and 110d may not be specifically assigned different playback responsibilities. That is, the merged playback devices 110b and 110d may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1I, the playback devices 110l and 110m may be bonded so as to produce or enhance a stereo effect of audio content. In this example, the playback device 110l may be configured to play a left channel audio component, while the playback device 110m may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1K shows the Front and SUB devices 110h and 110i further bonded with Left and Right playback devices 110j and 110k, respectively. In some implementations, the Left and Right devices 110j and 110k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n in the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in subsequently referenced U.S. Patent No. 10,499,146.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Patent No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining + Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variable instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining + Kitchen zone group 108b and that devices 110b and 110d are grouped (FIG. 1L). Identifiers associated with the Kitchen may indicate the same or similar information by virtue of the Kitchen being part of the Dining + Kitchen zone group 108b. Other example zone variables and identifiers are described below.

In yet another example, the memory may store variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D and I, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. Patent No. 10,712,997 filed Aug. 21, 2017, and titled “Room Association Based on Name,” and U.S. Patent No. 8,483,853 filed Sep. 11, 2007, and titled “Controlling and manipulating groupings in a multi-zone media system.” Each of these patents is incorporated herein by reference in its entirety. In some embodiments, the media playback system 100 may not implement Areas, in which case the system may not store variables associated with Areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) are configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other embodiments, however, the playback device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user’s perception of the sound emitted from the playback device 210.

In some examples, a filter is axially aligned with the transducer 214b. The filter can be configured to desirably attenuate a predetermined range of frequencies that the transducer 214b outputs to improve sound quality and a perceived sound stage output collectively by the transducers 214. In some embodiments, however, the playback device 210 omits the filter. In other embodiments, the playback device 210 includes one or more additional filters aligned with the transducers 214b and/or at least another of the transducers 214.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes or apertures 316d in the upper portion 316a allow sound to pass through to one or more microphones 315 (FIG. 3C) positioned within the housing 316. The one or more microphones 315 are configured to receive sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other embodiments, however, the NMD 320 includes a single transducer, or more than two (e.g., two, five, six) transducers. In certain embodiments, the NMD 320 omits the transducers 314a and 314b altogether.

Electronics 312 (FIG. 3C) includes components configured to drive the transducers 314a and 314b, and further configured to analyze audio data corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to FIG. 1F such as, for example, the one or more processors 112a, the memory 112b, the software components 112c, the network interface 112d, etc. In some embodiments, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control) that can be adjusted by a user 323. A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some embodiments, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user’s voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain embodiments, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312l, acoustic echo cancellation (AEC) and/or self-sound suppression components 312m, activation word detector components 312n, and voice/speech conversion components 312o (e.g., voice-to-text and text-to-voice). In the illustrated embodiment of FIG. 3E, the foregoing components 312k-312o are shown as separate components. In some embodiments, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise.

The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first- and third-party activation word detection algorithms are known and commercially available. For instance, operators of a voice service may make their algorithm available for use in third-party devices. Alternatively, an algorithm may be trained to detect certain activation words. In some embodiments, the activation word detector 312n runs multiple activation word detection algorithms on the received audio simultaneously (or substantially simultaneously). As noted above, different voice services (e.g., AMAZON’s ALEXA, APPLE’s SIRI, or MICROSOFT’s CORTANA) can each use a different activation word for invoking their respective voice service. To support multiple services, the activation word detector 312n may run the received audio through the activation word detection algorithm for each supported voice service in parallel.

The speech/text conversion components 312o may facilitate processing by converting speech in the voice input to text. In some embodiments, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include an activation word portion 328a and a voice utterance portion 328b. In some embodiments, the activation word 328a can be a known activation word, such as “Alexa,” which is associated with AMAZON’s ALEXA. In other embodiments, however, the voice input 328 may not include an activation word. In some embodiments, a network microphone device may output an audible and/or visible response upon detection of the activation word portion 328a. In addition, or alternately, an NMD may output an audible and/or visible response after processing a voice input and/or a series of voice inputs.

The voice utterance portion 328b may include, for example, one or more spoken commands (identified individually as a first command 328c and a second command 328e) and one or more spoken keywords (identified individually as a first keyword 328d and a second keyword 328f). In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some embodiments, the media playback system 100 is configured to temporarily reduce the volume of audio content that it is playing while detecting the activation word portion 328a. The media playback system 100 may restore the volume after processing the voice input 328, as shown in FIG. 3F. Such a process can be referred to as ducking, examples of which are disclosed in U.S. Patent No. 10,499,146, which is incorporated by reference herein in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433e includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify, Radio by Tunein, Apple Music, Pandora, Amazon, TV, local music, line-in) through which the user can browse and from which the user can select media content for play back via one or more playback devices (e.g., one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selects a graphical representation 433j (FIG. 4C), the control device 430 can be configured to begin play back of audio content corresponding to the graphical representation 433j and output a fourth user interface display 431d that includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533c, a playback zone region 533b, a playback queue region 533d, and a media content source region 533e. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a playback queue.

The playback zone region 533b can include representations of playback zones within the media playback system 100 (FIGS. 1A and 1B). In some embodiments, the graphical representations of playback zones may be selectable to bring up additional selectable icons to manage or configure the playback zones in the media playback system, such as a creation of bonded zones, creation of zone groups, separation of zone groups, renaming of zone groups, etc. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some embodiments, the control device 530 includes other interactions and implementations for grouping and ungrouping zones via the user interface 531. In certain embodiments, the representations of playback zones in the playback zone region 533b can be dynamically updated as playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device. In some embodiments, for example, a playlist can be added to a playback queue, in which information corresponding to each audio item in the playlist may be added to the playback queue. In some embodiments, audio items in a playback queue may be saved as a playlist. In certain embodiments, a playback queue may be empty, or populated but “not in use” when the playback zone or zone group is playing continuously streaming audio content, such as Internet radio that may continue to play until otherwise stopped, rather than discrete audio items that have playback durations. In some embodiments, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

### IV. Further Example Systems and Devices

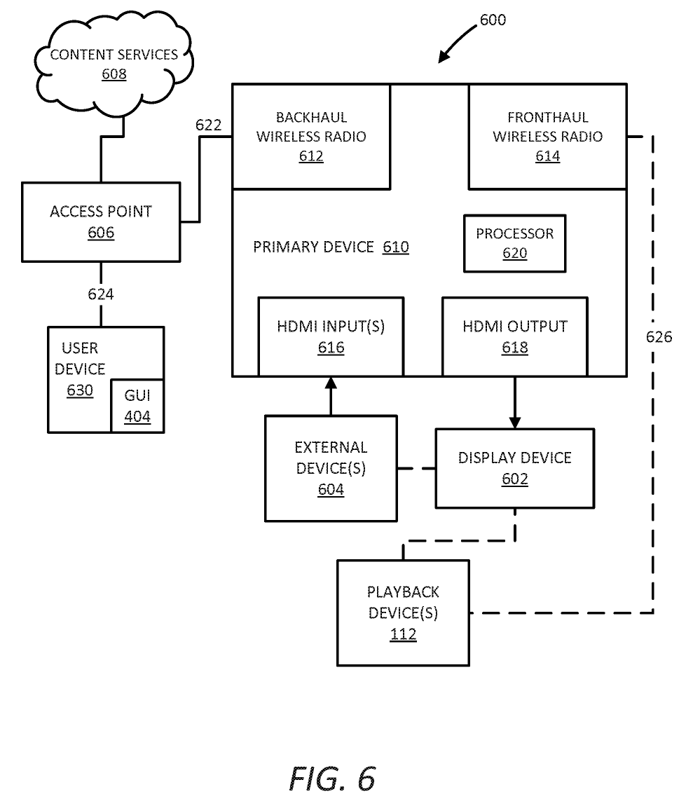

FIG. 6 is a block diagram of an example of a system 600 that may be part of a media playback system 110 configured in accordance with aspects of the disclosed technology. As shown, in this example, the system 600 includes a primary device 610, one or more playback device(s) 110 (e.g., a soundbar and/or satellite playback devices, as described further below), a display device 602, and one or more external devices 604 (e.g., a gaming console, DVD player, cable box, etc.). An access point (AP) 606 is also shown, along with content services 608 and a user device 630 (e.g., a smartphone, tablet, laptop, desktop computer, or the control device 130, including the user interface 133, as described above). The primary device 610 is shown to include a processor 620 (e.g., the processor(s) 322 described above), a backhaul radio 612, a fronthaul radio 614, one or more HDMI input interfaces 616, and an HDMI output interface 618. The backhaul radio 612 and the fronthaul radio 614 may be part of a wireless communication interface of the primary device 610 (e.g., the wireless interface 112e described above). The HDMI input interfaces 616, and the HDMI output interface 618 may be part of a wired communication interface of the primary device 610 (e.g., the wired interface 112f described above).

The display device 602, such as a television or smart TV, displays visual content. In some examples, the display device 602 also outputs audio content (which is associated with the displayed visual content) that can be provided to one or more of the playback devices 110, as described further below.

In some examples, the primary device 610 operates as a sourcing device for a bonded group (for example, a home theater group) that includes the playback device(s) 110. The satellite playback devices may play back certain channels (for example, as may playback devices 110d and 110f) and/or certain frequency ranges (for example, as does playback device 110k), as shown, for example, in FIG. 1J.

In some examples, primary playback device 610 is configured to use the backhaul radio 612 to communicate with the access point 606 via wireless communication link 622 (for example, a backhaul connection). The access point 606, in turn, may communicate with other devices, such as the user device 630 (for example, a smartphone, tablet, laptop, desktop computer, and so forth) via a wireless communication link 624. The primary device 610 and/or the user device 630 may obtain data (e.g., audio data and/or video data) from the content services 608 via the access point 606. The content services 608 may include one or more sources of audio data and/or video data (also referred to a visual data or visual content). Thus, for example, the primary device 610 may receive audio data and/or video data from streaming services (e.g., from applications executing on the user device 630 or over the Internet) that are part of the content services 608. For example, system 600 may play back audio from a music streaming service or audio/video content provider. In such instances, the primary device 610 may communicate with one or more cloud servers associated with a streaming service provider (for example, via the communication link 622 to the access point 606) to obtain the content for playback.

In some examples, the primary device 610 is also configured to use the fronthaul radio 614 to communicate with one or more of the playback devices 110 via one or more respective wireless communication links 626, as described further below. In some examples, the primary device 610 may communication with one or more of the playback devices 110 via one or more respective wired communication links (not shown in FIG. 6). In some instances, the display device 602 may be communicatively coupled (e.g., via a wired or wireless connection) to one or more of the playback devices 110, as also described further below. The primary device 610 is also capable of receiving audio and/or video data from the one or more external devices 602 via the HDMI input interface(s) 616. The primary device 610 is further capable of providing video data, and optionally audio data, to the display device 602 via the HDMI output interface 618, as described further below. In some instances, the display device 602 can be directly coupled to one or more of the external devices 604.

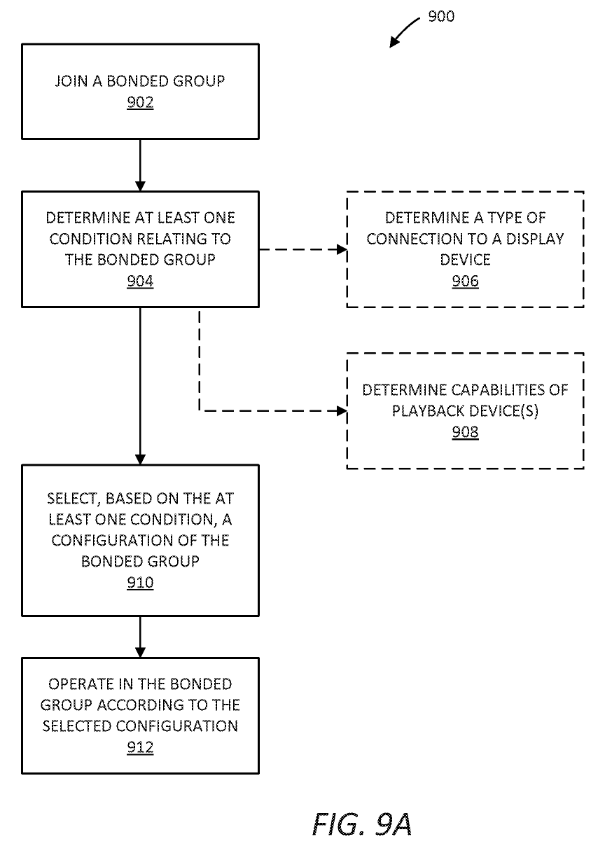

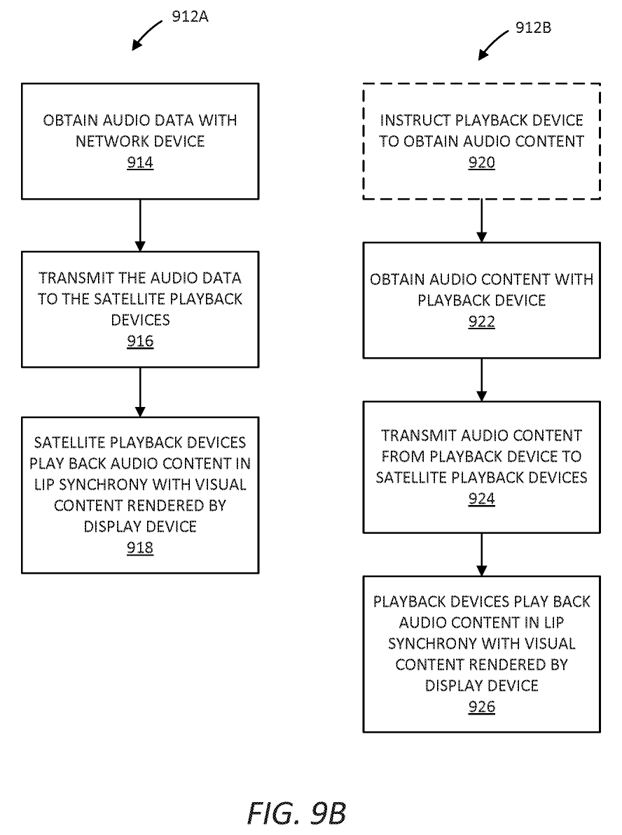

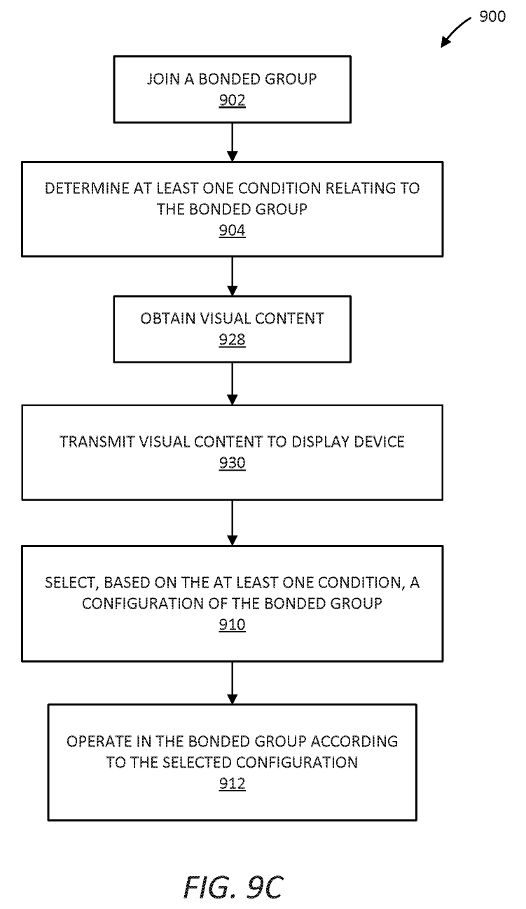

As described above, in some examples, when the primary device 610 is joined with the one or more playback devices 110 to form the bonded group, the primary device 610 can behave differently, or select a different operating configuration of the bonded group, based on certain conditions relating to the bonded group. For example, the primary device 610 may select among different configurations of the bonded group based on its connection with the display device 602 and/or based on capabilities of the playback devices 110. Methodologies associated with selecting a configuration of the bonded group, and operating accordingly, are described below with reference to FIGS. 9A-C.

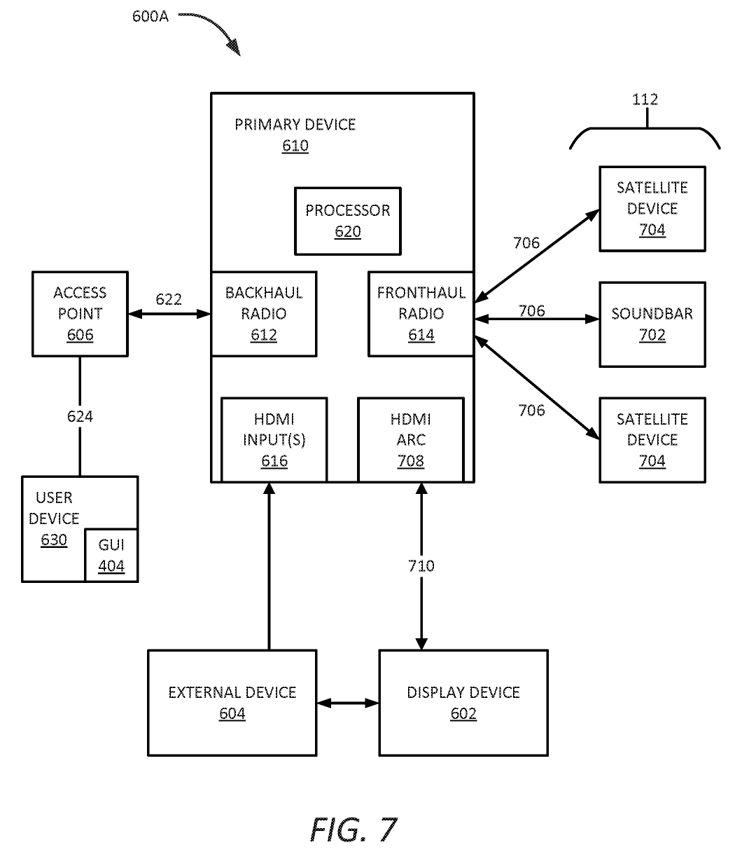

Referring now to FIG. 7, there is illustrated a first configuration 600A of the system 600. In this example, the playback devices 110 include a primary playback device (e.g., a soundbar 702) and a plurality of satellite playback devices 704. Although two satellite playback devices 704 are illustrated in FIG. 7, it will be appreciated that in other examples, there may be more or fewer than two satellite playback devices 704. Furthermore, in other examples, the soundbar 702 may be replaced with another type of playback device.

110. Thus, although the following description may refer to the soundbar 702, it will be appreciated that operations, attributes, and/or functions described below with reference to the soundbar 702 may be performed by or attributed to another playback device 110 that is not necessarily a soundbar.

In the example of FIG. 7, the primary device 610 is communicatively coupled with the playback devices 110 via wireless communication links 706 established via the fronthaul radio 614. However, as noted above, in other examples, the primary device 610 may be communicatively coupled with the playback devices 110 via wired or wireless communication links established via the network interface 112d, for example. Accordingly, although the following description may refer primarily to wireless communications links 706 established between the primary device 601 and the playback devices 110, it will be appreciated that any such link 706 may be replaced with a wired communication link, such as an Ethernet and/or USB connection, for example. Furthermore, in the example of FIG. 7, the primary device 610 includes an HDMI ARC interface 708. The primary device 610 is coupled to the display device 602 via an HDMI ARC communication link 710 established between the HDMI ARC interface 708 of the primary device 610 and an HDMI ARC port on the display device 602. Accordingly, in this configuration, in addition to being capable of receiving audio data via the backhaul connection 622 via the backhaul radio 612, the primary device 610 is also capable of receiving audio data from the display device 602 through the HDMI ARC interface 708 via the HDMI ARC communication link 710. Furthermore, the primary device 610 is capable of transmitting video data (e.g., received via the backhaul connection 622) to the display device 602 via the HDMI ARC communication link 710.

In some instances, the primary device 610 may acquire, via the user device 630, for example, a URL or other information specifying a source (e.g., in the content services 608) of audio and/or video data to be played back by the system 600. In such instances, the primary device may acquire the audio and/or video data from the content services 608 via the backhaul connection 622. In other examples, the audio and/or video data may be provided to the primary device 610 from the external device 604 via the HMDI input interface 616.

When operating in a home theater bonded group, for example, the primary device 610 can be configured to play back audio through the playback devices 110 in lip synchrony with video that is played back via the display device 602. For example, after receipt of audio content associated with visual content to be rendered by display device 602, the primary device 610 may communicate the received audio content (or any portion thereof) to the soundbar 702 and satellite playback devices 704, via the wireless communication links 706, using the fronthaul radio 614. Once the audio content has been communicated to the soundbar 702 and the satellite playback devices 704, those devices may render the audio content in synchrony with each other and in lip-synchrony with the visual content displayed on the display device 602. Furthermore, the primary device 610 can acquire the video data containing the visual content, for example via the backhaul connection 622 (e.g., from the user device 630 and/or content services 608 of FIG. 6) or from the external device 604 via the HDMI input 616, and provide the video data to the display device 602 via the HDMI ARC communication link 710. As described above, this arrangement may be advantageous in that the primary device 610 may delay display of the visual content by the display device 602 (e.g., by delaying transmission of the video data to the display device 602) to allow more time in which to provide the audio to the various playback devices 110 and reduce timing challenges associated with achieving lip synchrony.

In some examples, the primary device 610 is configured to establish the wireless communication links 706, via the fronthaul radio 614, in a 6 GHz frequency band. The use of a 6 GHz connection, rather than a 5 GHz or 2.4 GHz connection, allows for higher bandwidth data transmission, which may allow the system 600A to support a higher number of satellite playback devices 704. In such examples, the primary device 610 may establish the backhaul connection 622 in a different frequency band, such as a 5 GHz frequency band, to avoid interference with the fronthaul connections.

In the configuration 600A, the primary device 610 acts as the home theater coordinator, in some examples, handling distribution of the video data to the display device 602 and audio data to the playback devices 110, as described above. Accordingly, in this configuration 600A, the soundbar 702 may act as, or be considered as, a satellite playback device of the primary device 610. As described above, in the home theater bonded group, the playback devices 110 may each be responsible for playback of one or more audio channels of the audio data and/or may have different frequency responsibilities (e.g., if a satellite playback device 704 is a sub-woofer it may play back lower frequencies than, for example, another satellite playback device 704 that is a tweeter or mid-range speaker), as described above with reference to FIGS. 5B-D. Accordingly, in the configuration 600A, the primary device 610 may appropriately distribute some or all of the audio data to the various playback devices 110 (including the soundbar 702) in accord with their audio channel and/or frequency responsibilities, as described above.

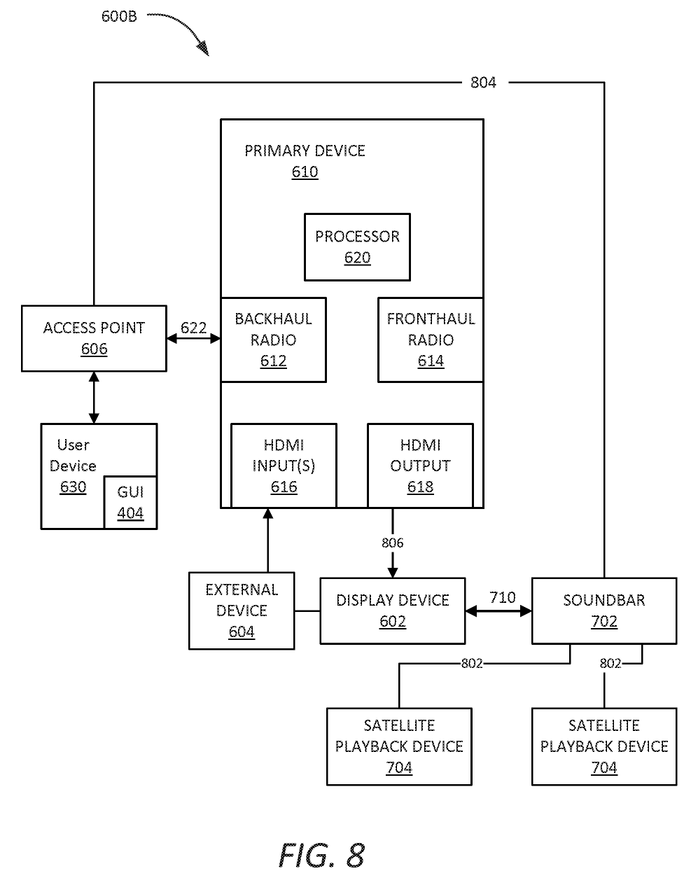

In some instances, however, the system 600 can be configured differently than shown in FIG. 7. For example, FIG. 8 is a block diagram illustrating a second configuration 600B of the system 600 in accordance with aspects of the disclosed technology. In this configuration 600B, the playback devices 110 (including the soundbar 702 and the satellite playback devices 704) are not connected to the fronthaul radio 614 of the primary device 610. Instead, the soundbar 702 is connected to the display device 602 over the HDMI ARC connection 710. The satellite playback devices 704 are connected to the soundbar 702 via wired or wireless communication links 802 (e.g., via the network interfaces 112d of the respective devices). The display device 602 is connected to the HDMI output interface 618 of the primary device 610. As such, the primary device 610 may provide video data to the display device 602 over a wired connection 806 between the HDMI output interface 618 of the primary device 610 and an HDMI port of the display device 602. The soundbar 702 may be connected to the access point 606 in the configuration 600B, for example over a wired or wireless communication connection link/connection 804, bypassing the primary device 610. According to certain examples, the soundbar 702 acquires audio data via the wired or wireless communication connection 804 and distributes at least some portion of the audio data (e.g., certain audio channels or frequency content) to the satellite playback device 704.

It will be appreciated that, in the configuration 600B, in some instances, the primary device 610 may be bypassed entirely. For example, the display device 602 may be directly connected to the external device 604 and receive audio and video data from the external device 604. The display device 602 may then provide the audio data to the soundbar 702 over the HDMI ARC connection 710, and the soundbar 702 distributes the audio data to the satellite playback devices 704 via the communication links 802. Thus, the soundbar 702 and the satellite playback devices 704 may render audio content in lip synchrony with visual content displayed by the display device 602, without participation by the primary device 610.

In other examples of the configuration 600B, the primary device may act as a controller from the home theater bonded group. For example, the primary device 610 may acquire via the user device 630, for example, a URL or other address information specifying a source (e.g., in the content services 608) of audio and/or video data to be played back by the system 600. For example, the address information may identify a particular media streaming service or other content source. The primary device 610 may acquire the video data via the backhaul connection 622 and provide the video data to the display device 602 via the wired connection 806, as described above. The primary device 610 may further provide the URL, or other information, to the soundbar 702 and direct the soundbar 702 to acquire the audio data via the communication connection 804. The primary device 610 may thus direct the display device 602 and the soundbar 702 to play back visual and audio content, respectively, in synchrony, while the soundbar 702 handles distribution of the audio content to (and coordination of playback by) the satellite playback devices 704.

In some instances, although the primary device 610 and the playback devices 110 may be joined in a bonded group, such as a home theater group, a user 123 (FIG. 1B) may direct the system 600 to play back only audio content, without display of visual content on the display device 602. In such examples, the primary device 610 may acquire the playback instruction via the user device 630. The primary device 610 may then direct the soundbar 702 (via the display device 602) to acquire the appropriate audio data via the communication connection 804, and coordinate playback of the audio content via the soundbar 702 itself and/or any one or more of the satellite playback devices 704. Alternatively, in such examples, the soundbar 702 may acquire the user’s instruction, and source information for the desired audio content, directly via its wireless connection 804 to the access point 606 (e.g., from the user device 630). Based on the instruction and information, the soundbar 702 may acquire the audio data and direct playback of the audio content without involving the primary device 610.

In some instances, the configuration 600B may result from a hardware limitation in which the soundbar 702 is not capable of wireless communication with the fronthaul radio 614 of the primary device 610. For example, the fronthaul radio 614 may use a 6 GHz wireless connection such as WI-FI 6E, while the soundbar 702 may be configured for WI-FI 7, WI-FI 6, WI-FI 5, or an earlier version of WI-FI. In some other cases, however, the configuration 600B may be selected by the user 123. For example, the user 123 may connect the soundbar 702 to an HDMI ARC port of the display device 602. As a result, unless the display device 602 has multiple HDMI ARC ports, a further HMDI ARC port may not be available for connecting the display device 602 to the primary device 610. Accordingly, the primary device 610 may be connected to the display device 602 via the HMDI output interface 618, which may not allow transmission of both audio and video data, in combination or simultaneously, to the display device 602 (as in the configuration 600A). In some examples, connecting the soundbar 702 to the HMDI ARC port of the display device 602 may prevent the soundbar 702 from establishing a connection to the fronthaul radio 614 of the primary device 610.

In such and/or other scenarios, rather than requiring the user 123 to troubleshoot problems that may arise from the configuration 600B in relation to the user’s desire to seamlessly use the primary device 610 control playback in a home theater (or other) bonded group arrangement, the primary device 610 can be configured to determine conditions of the bonded group (such as the capabilities of the soundbar 702 and/or the presence or absence of HDMI ARC connections) that relate to the configurations 600A or 600B, and adjust its operating behavior accordingly. For example, as described further below with reference to FIGS. 9A-C, the primary device 610 (e.g., using the processor 620) may determine whether or not it is connected to the display device 602 via the HDMI ARC connection 710. If not, upon receipt of instructions to playback media content in a home theater (or other) bonded group, the primary device 610 may operate according to the configuration 600B. For example, while the primary device 610 may handle distribution of video data to the display device 602, the primary device 610 may direct the soundbar 702 to handle acquisition, distribution, and coordination of playback of corresponding audio content, as described above.

Similarly, upon forming a bonded group with the playback devices 110, the primary device 610 can be configured to determine certain capabilities of the playback devices 110, such as whether or not the playback devices support certain wireless networking standards or protocols. The primary device 610 may then implement, or operate according to, aspects of the first configuration 600A or the second configuration 600B based on the capabilities of one or more of the playback devices 110 in the bonded group. For example, as described above, if the fronthaul radio of the primary device 610 is configured to establish fronthaul connections (e.g., the wireless communication links 706) in a 6 GHz frequency band, but the soundbar 702 does not support 6 GHz wireless networking, the primary device 610 may configure the bonded group according to the second configuration 600B in which the soundbar 702 may obtain the audio data from the access point 606 via the wireless connection 804 (which may be established in another frequency band, such as a 5 GHz frequency band, for example). Alternatively, if all the playback devices 110 in the bonded group support wireless networking compatible with fronthaul connections to be established via the fronthaul radio of the primary device 610, the primary device 610 may configure the bonded group according to the configuration 600A and distribute the audio data to the playback devices 110 as described above with reference to FIG. 7. In some examples, to determine the capabilities of the playback devices 110 in the bonded group, the primary device 610 may access (e.g., upon bonding, receipt of an instruction to form a bonded group, or thereafter) a data file that specifies the capabilities of the playback devices 110. The primary device 610 may then use this information to appropriately configure data distribution communication links among the playback devices 110, as described above.

### V. Example Methodology

FIG. 9A is a flowchart illustrating an example method 900 for operating a bonded group in accordance with aspects of the technology described herein. Operations and aspects of the method 900 may be performed by one or more network devices in the media playback system 110 (or system 600), including the primary device 610 and/or the soundbar 702 (or another playback device 110). For example, a network device may include non-transitory data storage (e.g., the memory 112b described above with reference to FIG. 1C) that stores program instructions (e.g., software code) that when executed by a processor (e.g., processor(s) 112a or processor 132a) configure or cause the network device to implement aspects and/or operations of the method 900.

Operation 902 includes joining a bonded group comprising one or more playback devices that play back audio content associated with visual content in lip-synchrony with rendering of the visual content on the display device 602. Operation 902 may include joining, by the primary device 610, the bonded group with the playback devices 110 (e.g., the soundbar 702 and the satellite playback devices 704).

Operation 904 includes determining at least one condition relating to the bonded group. In some examples, operation 904 is performed by the primary device 610. As described above, operation 904 may include an operation 906 of determining a type of connection between the network device and the display device 602. For example, as described above, operation 906 may include determining (e.g., by the primary device 610) whether the primary device 610 is connected to the display device 602 via an HDMI ARC connection. Operation 906 may include determining whether the soundbar 702 (or other playback device 110) is connected to the display device 602 via an HDMI ARC connection. As described above, operation 904 may further include an operation 908 of determining capabilities of one or more of the playback devices 110 (e.g., the soundbar 702 and/or the satellite playback devices 704) in the bonded group. For example, as described above, the primary device can determine whether the soundbar 702 and/or the satellite playback devices 704 have wireless networking capabilities to support establishing fronthaul connections (e.g., the wireless communication links 706) with the primary device 610, such that the primary device 610 can distribute audio data to the playback devices 110 as described above with reference to FIG. 7.

Based on the condition(s) determined at operation 904, the method 900 may include an operation 910 of selecting an appropriate or compatible configuration of the bonded group. For example, at operation 910, the primary device 610 may select either a first configuration corresponding to at least certain aspects of configuration 600A (in which the playback devices 110 are satellites of the primary device 610) or a second configuration corresponding to at least certain aspects of the configuration 600B (in which the satellite playback devices 704 are satellites of the soundbar 702).

The method 900 further includes an operation 912 of operating in the bonded group according to the configuration selected at operation 910. For example, at operation 912, the primary device 610 and/or the playback devices 110 may operate in accord with the selected configuration. FIG. 9B illustrates examples of operation 912 for two different configurations of the bonded group.

For example, operation 912A (corresponding to a first configuration of the bonded group) may include an operation 914 of obtaining audio content with a network device (e.g., the primary device 610) and an operation 916 of transmitting the audio content from the network device to the satellite playback devices 110 in the bonded group. In some examples, operation 912A may be performed in a bonded group configuration similar to the configuration 600A illustrated in FIG. 7 and described above. For example, at operation 914, the primary device 610 may obtain audio data via the backhaul connection 622 or via the HDMI input interface 616. At operation 916 the primary device 610 may distribute at least some of the audio data to the playback devices 702, 704 that are configured as satellites of the primary device. As described above, in this configuration, the primary device 610 may distribute the audio data to the playback devices 702, 704 via the wireless communication links 706 established via the fronthaul radio 614. At operation 918, the playback devices 702, 704 play back the audio content in lip synchrony with rendering of the visual content on the display device 602.

Still referring to FIG. 9B, in another example, operation 912B (corresponding to a second configuration of the bonded group) may include an operation 920 of instructing a playback device 110 to obtain audio content. For example, in a system configuration such that the configuration 600B of FIG. 8, the primary device 610 (or the user device 630, for example) may instruct the soundbar 702 to obtain audio data comprising the audio content via its communication connection 804 with the access point 606. At operation 922, the soundbar 702 (or another playback device 110) obtains the audio data comprising the audio content. At operation 924, the soundbar 702 (or another playback device 110) distributes at least some of the audio data to the satellite playback devices 704, as described above with reference to FIG. 8. At operation 926, the playback devices (e.g., the soundbar 702 and/or the satellite playback devices 704) play back the audio content in lip synchrony with rendering of the visual content on the display device 602.

Thus, at operation 912, various devices (such as the primary device 610 and/or the soundbar 702) can perform different operations to operate differently in the bonded group depending on the configuration that is selected at operation 910.

Turning to FIG. 9C, in some examples, the method 900 further includes an operation 928 of obtaining video data that includes the visual content to be rendered by the display device 602. In some examples, the display device 602 obtains the video data from the external device 604. However, in other examples, a network device (e.g., the primary device 610) obtains the video data at operation 928 and, at operation 930, transmits the video data to the display device 602. For example, as described above, the primary device 610 may obtain the video data via the backhaul connection 622 (optionally in combination with the audio data) or via the HDMI input interface 616. The primary device 610, at operation 930, may transmit the video data to the display device 602, for example, via the HDMI output interface 618 or the HDMI ARC connection 710, depending on the system configuration, as described above.

### VI. Conclusion

The above descriptions relating to playback devices, controller devices, playback group configurations, and media content sources provide only some examples of operating environments within which functions and methods described herein may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain examples described herein can be practiced without certain, specific details. In other instances, well known methods, procedures, components, and circuitry have not been described in detail to avoid unnecessarily obscuring aspects of the examples. Accordingly, the scope of the present disclosure is defined by the appended claims rather than the foregoing description of examples.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### VII. Additional Examples

The following examples pertain to further arrangements and/or implementations, from which numerous permutations and configurations will be apparent.

Example 1 is a network device comprising: a wireless communication interface including at least one radio configured to communicate within a wireless network; a wired communication interface; at least one processor; and at least one non-transitory computer-readable medium storing program instructions that are executable by the at least one processor such that the network device is configured to join a bonded group comprising at least one playback device configured to play back audio content associated with visual content in lip-synchrony with rendering of the visual content on a display device that is connected to the network device via the wired communication interface, obtain the visual content via the wireless communication interface, transmit the visual content to the display device via the wired communication interface, select, based on at least one condition, either a first configuration of the bonded group or a second configuration of the bonded group, the at least one condition including one or more of (i) a type of connection between the network device and the display device or (ii) a capability of the at least one playback device, and operate in the bonded group according to the first configuration of the bonded group or the second configuration of the bonded group.

Example 2 includes the network device of Example 1, wherein to operate in the bonded group in the first configuration of the bonded group comprises to: obtain the audio content via the wireless communication interface; and transmit the audio content to the at least one playback device via the wireless communication interface.

Example 3 includes the network device of Example 2, wherein the at least one radio comprises: a backhaul radio configured to communicate over a first wireless network to obtain the audio content; and a fronthaul radio configured to transmit the audio content to the at least one playback device through a second wireless network.

Example 4 includes the network device of Example 3, wherein operating frequency bands of the first and second wireless networks are different.

Example 5 includes the network device of Example 4, wherein the first wireless network comprises a 5 GHz wireless network, and wherein the second wireless network comprises a 6 GHz wireless network.

Example 6 includes the network device of any one of Examples 2-5, wherein the at least one playback device comprises a plurality of playback devices, wherein the audio content comprises multi-channel audio content, and wherein the network device is configured to transmit individual audio channels of the multi-channel audio content to respective playback devices of the plurality of playback devices via the wireless communication interface.

Example 7 includes the network device of any one of Examples 2-6, wherein the at least one condition comprises the type of connection between the network device and the display device, and wherein the network device is configured to select the first configuration based at least in part on the type of connection between the network device and the display device being a High-Definition Multimedia Interface (HDMI) audio return channel (ARC) interface.

Example 8 includes the network device of any one of Examples 2-7, wherein the at least one condition comprises the capability of the at least one playback device, and wherein the network device is configured to select the first configuration based at least in part on the capability of the at least one playback device including a capability to connect to a 6 GHz wireless network.

Example 9 includes the network device of any one of Examples 1-8, wherein the program instructions include program instructions that are executable by the at least one processor such that the network device is configured to determine the capability of the at least one playback device by accessing configuration data that specifies capabilities of the at least one playback device.

Example 10 is a method of operating a media playback system comprising a primary playback device, a network device, and a plurality of satellite playback devices. The method comprises forming a bonded group that includes the plurality of satellite playback devices, the primary playback device, and the network device, the plurality of satellite playback devices being configured, in the bonded group, to play back audio content associated with visual content in lip-synchrony with rendering of the visual content on a display device that is connected to the network device; determining a type of connection between the display device and the network device; determining capabilities of the plurality of satellite playback devices; selecting, based on the type of connection between the display device and the network device and/or based on the capabilities of the plurality of satellite playback devices, a first configuration of the bonded group or a second configuration of the bonded group; and operating the bonded group according to either the first configuration or the second configuration. Operating in the bonded group in the first configuration includes obtaining, with the network device, the audio content via a network access point, transmitting the audio content from the network device to the plurality of satellite playback devices and to the primary playback device, and transmitting the visual content from the network device to the display device. Operating the bonded group in the second configuration includes obtaining, with the primary playback device, the audio content via the network access point, transmitting the audio content from the primary playback device to the plurality of satellite playback devices, and transmitting the visual content from the network device to the display device.

Example 11 includes the method of Example 10, wherein the network device includes a High-Definition Multimedia Interface (HDMI) interface, and wherein selecting the first configuration of the bonded group or the second configuration of the bonded group includes selecting the first configuration of the bonded group based at least in part on determining that the type of connection between the display device and the network device is an HDMI audio return channel (ARC) interface.

Example 12 includes the method of one of Examples 10 or 11, wherein selecting the first configuration of the bonded group or the second configuration of the bonded group includes selecting the first configuration of the bonded group based at least in part on determining that the capabilities of the plurality of satellite playback devices include a capability to connect to a 6 GHz wireless network.

Example 13 includes the method of Example 12, wherein the network device comprises a wireless communication including a fronthaul radio and a backhaul radio, and wherein: obtaining, with the network device, the audio content via the network access point includes connecting the network device to a 5 GHz wireless network or a 2.4 GHz wireless network using the backhaul radio; and transmitting the audio content from the network device to the plurality of satellite playback devices and to the primary playback device includes transmitting the audio content with the fronthaul radio over the 6 GHz wireless network.

Example 14 includes the method of any one of Examples 10-13, wherein determining the capabilities of the plurality of satellite playback devices includes accessing, with the network device, a data file that specifies the capabilities of the plurality of satellite playback devices.

Example 15 include the method of any one of Examples 10-14, wherein obtaining, with the network device or the primary playback device, the audio content via the network access point includes obtaining multi-channel audio content; and wherein transmitting the audio content from the primary playback device or the network device to the plurality of satellite playback devices includes transmitting individual audio channels of the multi-channel audio content to respective satellite playback devices of the plurality of satellite playback devices.

Example 16 includes the method of any one of Examples 10-15, wherein operating the bonded group in the first configuration or the second configuration comprises: obtaining, with the network device, the visual content from a media streaming service via the network access point; and obtaining, with the network device or the primary playback device, the audio content includes obtaining the audio content from the media streaming service.

Example 17 includes the method of Example 16, further comprising obtaining from a control device coupled to the network access point, address information identifying the media streaming service.

Example 18 includes the method of any one of Examples 10-17, further comprising: detecting an instruction to play back, via the plurality of satellite playback devices and the primary playback device, audio content that is not associated with visual content; and based on the instruction, bypassing the network device to obtain the audio content that is not associated with visual content via the network access point using the primary playback device, transmit, from the primary playback device, one or more audio channels of the audio content that is not associated with visual content to the plurality of satellite playback devices, and instruct, with the primary playback device, the plurality of satellite playback devices to playback the one or more audio channels of the audio content that is not associated with visual content in synchrony with one another.

Example 19 is a network device configured to implement, in whole or in part, the method of any one of Examples 10-18.

Example 20 is a media playback system configured to implement the method if any one of Examples 10-18.

Example 21 is a network device comprising: a wireless communication interface including a fronthaul radio configured to communicate over a first wireless network and a backhaul radio configured to communicate over a second wireless network; a first High-Definition Multimedia Interface (HDMI) interface; at least one processor; and at least one non-transitory computer-readable medium storing program instructions that are executable by the at least one processor such that the network device is configured to: join a bonded group comprising a plurality of playback devices that play back audio content associated with visual content in lip-synchrony with rendering of the visual content on a display device that is connected to the network device via the first HDMI interface; obtain the visual content; transmit the visual content to the display device via the first HDMI interface; select an operating configuration of the bonded group based at least one of a type of the first HDMI interface and wireless networking capabilities of the plurality of playback devices; and operate in a selected operating configuration of the bonded group. To operate in a first selected operating configuration includes to obtain the audio content, establish, with the fronthaul radio, the first wireless network among the network device and the plurality of playback devices, and transmit the audio content to the plurality of playback devices via the first wireless network. To operate in a second selected operating configuration includes to instruct a first playback device of the plurality of playback devices to obtain the audio content and to distribute the audio content to others of the plurality of playback devices.

Example 22 includes the network device of Example 21, wherein to select the operating configuration of the bonded group includes to select the first selected operating configuration based on the first HDMI interface being an HDMI audio return channel (ARC) interface.

Example 23 includes the network device of Example 22, wherein to select the operating configuration of the bonded group includes to select the first selected operating configuration further based on the wireless networking capabilities of the plurality of playback devices including a capability to connect to a 6 GHz wireless network.

Example 24 includes the network device of any one of Examples 21-23, wherein to operate in the first selected operating configuration includes to obtain the audio content over the second wireless network via the backhaul radio.

Example 25 includes the network device of any one of Examples 21-24, wherein to obtain the visual content includes to obtain the visual content via the backhaul radio.

Example 26 includes the network device of any one of Examples 21-25, further comprising a second HDMI interface; wherein to obtain the audio content includes to obtain the audio content via the second HDMI interface, and wherein to obtain the visual content includes to obtain the visual content via the second HDMI interface.

1. A network device comprising:
a wireless communication interface including at least one radio configured to communicate within a wireless network;
a wired communication interface;
at least one processor; and
at least one non-transitory computer-readable medium storing program instructions that are executable by the at least one processor such that the network device is configured to
join a bonded group comprising at least one playback device configured to play back audio content associated with visual content in lip-synchrony with rendering of the visual content on a display device that is connected to the network device via the wired communication interface,
obtain the visual content via the wireless communication interface,
transmit the visual content to the display device via the wired communication interface,
select, based on at least one condition, either a first configuration of the bonded group or a second configuration of the bonded group, the at least one condition including one or more of (i) a type of connection between the network device and the display device, or (ii) a capability of the at least one playback device, and
operate in the bonded group according to the first configuration of the bonded group or the second configuration of the bonded group.

2. The network device of claim 1, wherein to operate in the bonded group in the first configuration of the bonded group comprises to:
obtain the audio content via the wireless communication interface; and
transmit the audio content to the at least one playback device via the wireless communication interface.

3. The network device of claim 2, wherein the at least one radio comprises:
a backhaul radio configured to communicate over a first wireless network to obtain the audio content; and
a fronthaul radio configured to transmit the audio content to the at least one playback device through a second wireless network;
wherein operating frequency bands of the first and second wireless networks are different.

4. The network device of claim 3, wherein the first wireless network comprises a 5 GHz wireless network; and
wherein the second wireless network comprises a 6 GHz wireless network.

5. The network device of claim 2, wherein the at least one playback device comprises a plurality of playback devices;
wherein the audio content comprises multi-channel audio content; and
wherein the network device is configured to transmit individual audio channels of the multi-channel audio content to respective playback devices of the plurality of playback devices via the wireless communication interface.

6. The network device of claim 2, wherein the at least one condition comprises the type of connection between the network device and the display device; and
wherein the network device is configured to select the first configuration based at least in part on the type of connection between the network device and the display device being a High-Definition Multimedia Interface (HDMI) audio return channel (ARC) interface.

7. The network device of claim 2, wherein the at least one condition comprises the capability of the at least one playback device; and
wherein the network device is configured to select the first configuration based at least in part on the capability of the at least one playback device including a capability to connect to a 6 GHz wireless network.

8. The network device of claim 1, wherein the program instructions include program instructions that are executable by the at least one processor such that the network device is configured to:
determine the capability of the at least one playback device by accessing configuration data that specifies capabilities of the at least one playback device.

9. A method of operating a media playback system comprising a primary playback device, a network device, and a plurality of satellite playback devices, the method comprising:
forming a bonded group that includes the plurality of satellite playback devices, the primary playback device, and the network device, the plurality of satellite playback devices being configured, in the bonded group, to play back audio content associated with visual content in lip-synchrony with rendering of the visual content on a display device that is connected to the network device;
determining a type of connection between the display device and the network device;
determining capabilities of the plurality of satellite playback devices;
selecting, based on the type of connection between the display device and the network device and/or based on the capabilities of the plurality of satellite playback devices, a first configuration of the bonded group or a second configuration of the bonded group; and
operating the bonded group according to either the first configuration or the second configuration;
wherein operating in the bonded group in the first configuration includes
obtaining, with the network device, the audio content via a network access point,
transmitting the audio content from the network device to the plurality of satellite playback devices and to the primary playback device, and
transmitting the visual content from the network device to the display device; and
wherein operating the bonded group in the second configuration includes
obtaining, with the primary playback device, the audio content via the network access point,
transmitting the audio content from the primary playback device to the plurality of satellite playback devices, and
transmitting the visual content from the network device to the display device.

10. The method of claim 9, wherein the network device includes a High-Definition Multimedia Interface (HDMI) interface; and
wherein selecting the first configuration of the bonded group or the second configuration of the bonded group includes selecting the first configuration of the bonded group based at least in part on determining that the type of connection between the display device and the network device is an HDMI audio return channel (ARC) interface.

11. The method of claim 9, wherein selecting the first configuration of the bonded group or the second configuration of the bonded group includes selecting the first configuration of the bonded group based at least in part on determining that the capabilities of the plurality of satellite playback devices include a capability to connect to a 6 GHz wireless network.

12. The method of claim 11, wherein the network device comprises a wireless communication including a fronthaul radio and a backhaul radio, and wherein:
obtaining, with the network device, the audio content via the network access point includes connecting the network device to a 5 GHz wireless network or a 2.4 GHz wireless network using the backhaul radio; and
transmitting the audio content from the network device to the plurality of satellite playback devices and to the primary playback device includes transmitting the audio content with the fronthaul radio over the 6 GHz wireless network.

13. The method of claim 9, wherein obtaining, with the network device or the primary playback device, the audio content via the network access point includes obtaining multi-channel audio content; and
wherein transmitting the audio content from the primary playback device or the network device to the plurality of satellite playback devices includes transmitting individual audio channels of the multi-channel audio content to respective satellite playback devices of the plurality of satellite playback devices.

14. The method of claim 9, wherein operating the bonded group in the first configuration or the second configuration comprises:
obtaining from a control device coupled to the network access point, address information identifying a media streaming service;
obtaining, with the network device, the visual content from the media streaming service via the network access point; and
obtaining, with the network device or the primary playback device, the audio content includes obtaining the audio content from the media streaming service.

15. The method of claim 9, further comprising:
detecting an instruction to play back, via the plurality of satellite playback devices and the primary playback device, audio content that is not associated with visual content;
based on the instruction, bypassing the network device to
obtain the audio content that is not associated with visual content via the network access point using the primary playback device, and
transmit, from the primary playback device, one or more audio channels of the audio content that is not associated with visual content to the plurality of satellite playback devices, and
instruct, with the primary playback device, the plurality of satellite playback devices to playback the one or more audio channels of the audio content that is not associated with visual content in synchrony with one another.

16. A network device comprising:
a wireless communication interface including a fronthaul radio configured to communicate over a first wireless network and a backhaul radio configured to communicate over a second wireless network;
a first High-Definition Multimedia Interface (HDMI) interface;
at least one processor; and
at least one non-transitory computer-readable medium storing program instructions that are executable by the at least one processor such that the network device is configured to:
join a bonded group comprising a plurality of playback devices that play back audio content associated with visual content in lip-synchrony with rendering of the visual content on a display device that is connected to the network device via the first HDMI interface;
obtain the visual content;
transmit the visual content to the display device via the first HDMI interface;
select an operating configuration of the bonded group based at least one of a type of the first HDMI interface and wireless networking capabilities of the plurality of playback devices; and
operate in a selected operating configuration of the bonded group;
wherein to operate in a first selected operating configuration includes to
obtain the audio content,
establish, with the fronthaul radio, the first wireless network among the network device and the plurality of playback devices, and
transmit the audio content to the plurality of playback devices via the first wireless network; and
wherein to operate in a second selected operating configuration includes to
instruct a first playback device of the plurality of playback devices to obtain the audio content and to distribute the audio content to others of the plurality of playback devices.

17. The network device of claim 16, wherein to select the operating configuration of the bonded group includes to select the first selected operating configuration based on the first HDMI interface being an HDMI audio return channel (ARC) interface.

18. The network device of claim 17, wherein to select the operating configuration of the bonded group includes to select the first selected operating configuration further based on the wireless networking capabilities of the plurality of playback devices including a capability to connect to a 6 GHz wireless network.

19. The network device of claim 16, wherein to operate in the first selected operating configuration includes to obtain the audio content over the second wireless network via the backhaul radio; and
wherein to obtain the visual content includes to obtain the visual content via the backhaul radio.

20. The network device of claim 16, further comprising:
a second HDMI interface;
wherein to obtain the audio content includes to obtain the audio content via the second HDMI interface; and
wherein to obtain the visual content includes to obtain the visual content via the second HDMI interface.
